(19) United States
(12) Patent Application Publication
(10) Pub. No.: US 2013/0080165 A1
(43) Pub. Date: Mar. 28, 2013

(54) Model Based Online Normalization of Feature Distribution for Noise Robust Speech Recognition

(71) Applicants: Shizen Wang, Bellevue, WA (US); Yifan Gong, Sammamish, WA (US)

(72) Inventors: Shizen Wang, Bellevue, WA (US); Yifan Gong, Sammamish, WA (US)

(73) Assignee: Microsoft Corporation, Redmond, WA (US)

(21) Appl. No.: 13/244,331

(22) Filed: Sep. 24, 2011

(51) Int. Cl. G10L 15/00

(52) U.S. Cl. 704/236; 704/E15.001

(57) ABSTRACT

Online histogram recognition may be provided. Upon receiving a spoken phrase from a user, a histogram/frequency distribution may be estimated on the spoken phrase according to a prior distribution. The histogram distribution may be equalized and then provided to a spoken language understanding application.

### BACKGROUND

Histogram Equalization (HEQ) may be used to improve the robustness of spoken language understanding (SLU) applications. Reliable histogram estimation is critical to the performance of histogram equalization (HEQ). Conventional HEQ techniques are mostly working offline by applying utterance-based histogram estimation, and require seconds or even minutes of data for reliable estimation. Most real world applications cannot afford such high latencies, and demand real-time (online) histogram estimation and equalization algorithms, which has extremely low, if not zero, latencies.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Online histogram equalization/normalization may be provided. Upon receiving a spoken phrase from a user, a histogram/frequency distribution may be estimated on the spoken phrase according to a prior distribution. The histogram distribution may be equalized and then provided to a spoken language understanding application.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing histogram equalization; and

FIG. 3 is a block diagram of a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention.

Consistent with embodiments of the invention, a Gaussian Mixture Model (GMM) may be learned from training data and used as a reference histogram distribution. Online frame-by-frame adaptation may be applied to update the distribution with incoming test utterances. Normalization of the resulting distribution, such as through histogram equalization (HEQ), may improve speech recognition performance without introducing any latency.

The GMM may be used as a reference to characterize an utterance's histogram, with the GMM parameters learned from training data. This reference GMM may be updated in real time, frame-by-frame, on a test utterance using Maximum Likelihood (ML) or Maximum a posterie (MAP) criterion. A sliding window of length L is used for the adaptation, which consists of P previous frames plus 1 current frame. Depending on the amount of available data, a linear weighting is applied between the reference GMM and the adapted GMM to achieve robustness for short utterances.

Histogram Equalization (HEQ) may improve the noise robustness of speech recognition. An online, real-time HEQ may apply a model based histogram estimation that uses distribution learned on training data as a prior data set. The model may use parameters learned from collected training data using data driven methods and/or empirically defined, such as via a standard norm distribution. The prior distribution data may be updated with incoming spoken phrases, words, and/or utterances in real time. The updated distribution may then be normalized online for further processing.

Adaptation of a model-based HEQ method, such as GMM, may require less data than estimation of a full non-parametric histogram would, and such a GMM histogram estimation algorithm may be more reliable. Using a parametric GMM for histogram estimation may also result in a much smoother histogram, and thus result in better and more robust HEQ performance.

Online adaptation of a model based histogram/frequency distribution estimation may be performed using a sliding window. In contrast to previous solutions based on non-parametric techniques, the online adaptation uses a parametric model-based estimation technique. A Gaussian Mixture Model (GMM) may be used as a reference prior distribution with the GMM parameters, such as means, variances and weights, learned from some training data. However, the online adaptation algorithm need not make any assumptions on the prior distributions, and may be applied to other distribution functions. For each incoming utterance, the reference prior distribution may be updated in real time using maximum likelihood (ML), maximum a posteriori (MAP), and/or any other estimation criterions. A sliding window may be used for the update, tracking statistics accumulated up to a current window. Depending on the amount of available data, a further interpolation may be applied between the prior distribution and the updated distribution to achieve robustness for short utterances.

The normalized features may then be provided to a spoken language understanding application that is operative to convert the utterance into a query and/or request to perform an action. For example, the user's utterance may comprise a search string associated with a web search engine application. The spoken language understanding application may use the normalized feature vectors to accurately convert the spoken utterance into a text string that may then be further processed, such as by providing the text string to the search engine and returning the results to the user.

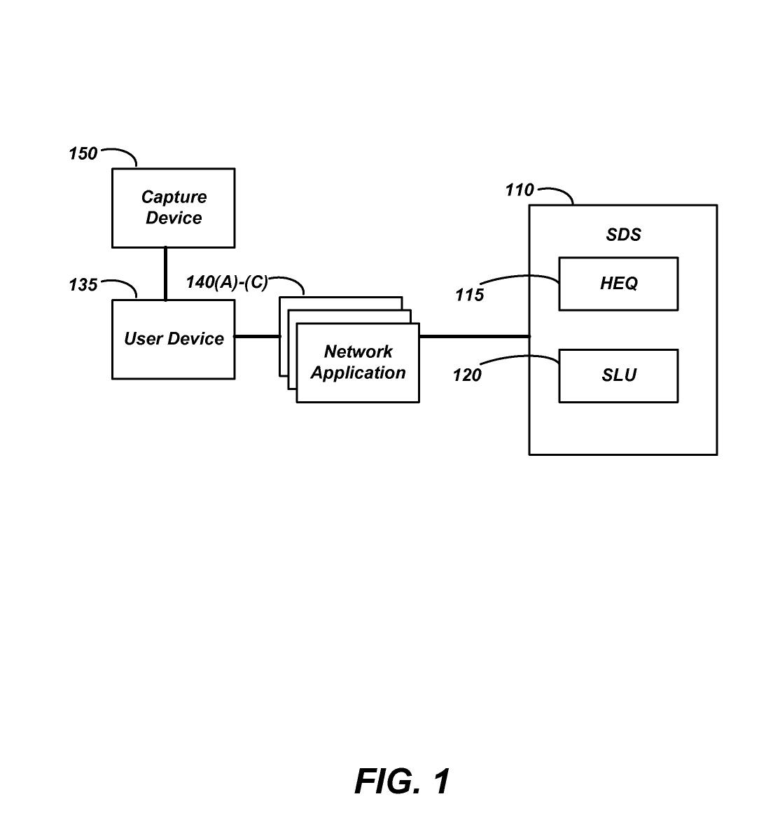

FIG. 1 is a block diagram of an operating environment 100 for providing online histogram equalization comprising a spoken dialog system (SDS) 110. SDS 110 may comprise a histogram equalization (HEQ) module 115 and a spoken language understanding application 120. SDS 110 may be operative to interact with a plurality of network applications 140(A)-(C) and/or a user device 135. User device 135 may comprise an electronic communications device such as a computer, laptop, cellular and/or IP phone, tablet, game console and/or other device. User device 135 may be coupled to a capture device 150 that may be operative to record a user and capture spoken words, motions and/or gestures made by the user, such as with a camera and/or microphone. User device 135 may be further operative to capture other inputs from the user such as by a keyboard, touchscreen and/or mouse (not pictured). Consistent with embodiments of the invention, capture device 150 may comprise any speech and/or motion detection device capable of detecting the speech and/or actions of the user. For example, capture device 150 may comprise a Microsoft® Kinect® motion capture device comprising a plurality of cameras and a plurality of microphones.

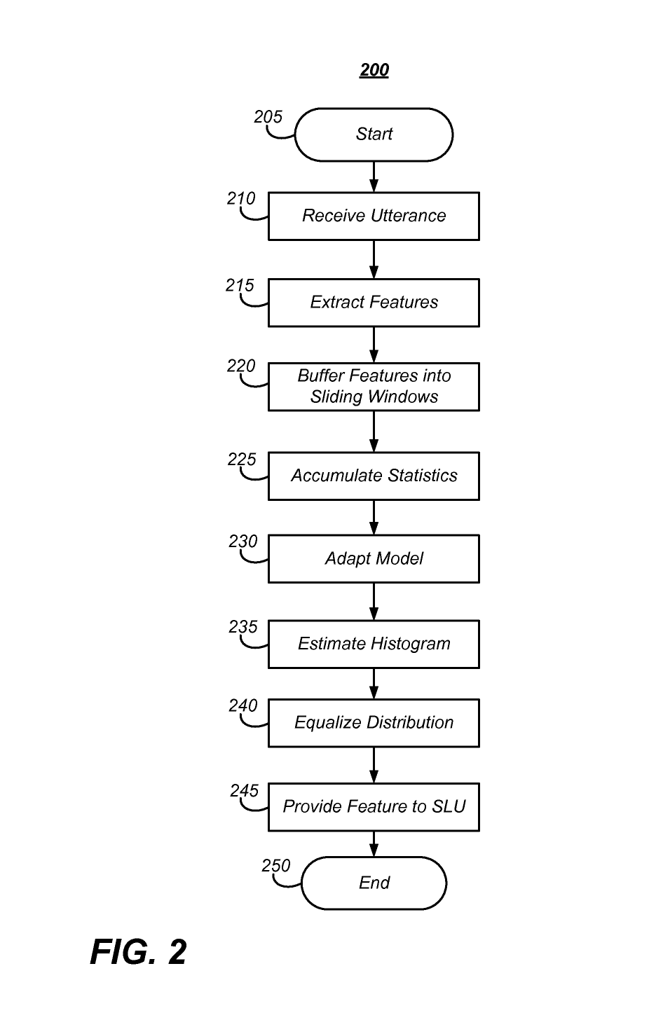

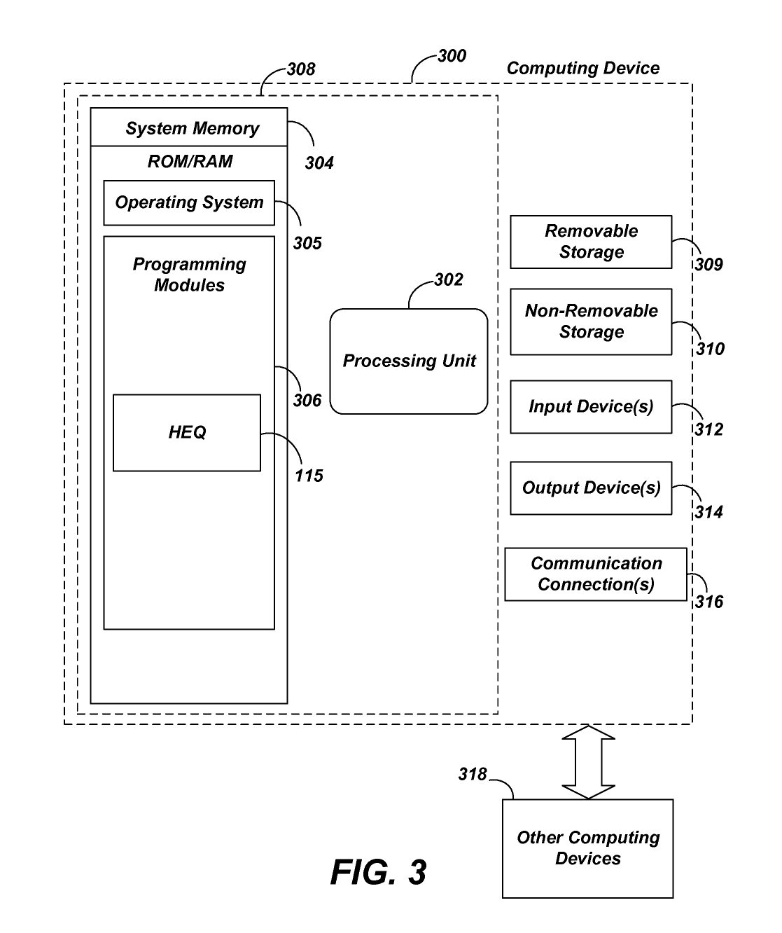

FIG. 2 is a flow chart setting forth the general stages involved in a method 200 consistent with an embodiment of the invention for providing statistical dialog manager training. Method 200 may be implemented using a computing device 300 as described in more detail below with respect to FIG. 3. Ways to implement the stages of method 200 will be described in greater detail below. Method 200 may begin at starting block 205 and proceed to stage 210 where computing device 300 may receive an utterance from a user of an application. For example, user device 135 may capture a spoken phrase from the user. The user may, for example, be addressing a search engine application executing on user device 135.

Method 200 may then advance to stage 215 where computing device 300 may perform a feature extraction on the utterance. For example, the input signal of the speech may be parameterized into a plurality of feature vectors. Such feature vectors may comprise, for example, Mel-frequency cepstral coefficients (MFCC) feature vectors and/or perceptual linear predictive (PLP) feature vectors.

Method 200 may then advance to stage 220 where computing device 300 may buffer the extracted features into a sliding window. A sliding window of length L may be used to buffer data for the online histogram equalization (HEQ) algorithm. If t<L, which means the sliding window is not full yet, the current feature frame may be saved in the window without other operations. Otherwise, the oldest feature vector frame may be moved out of the window with the current frame at the end. This may use a circular buffer implemented through manipulating data pointers. This may be applied to capture systems with and/or without looking ahead. If a small amount of looking ahead is allowed by the capture system, which means frames at future time t+n can be used, the equalization may be applied on frame t−n; otherwise the current frame t will be used.

Method 200 may then advance to stage 225 where computing device 300 may accumulate statistics on at least one of the buffered features. For example, the accumulated statistics may comprise a maximum likelihood (ML) criterion and/or a maximum a posteriori (MAP) criterion. A prior distribution of data may be learned from training data. After receiving a set of training data associated with an application, such as the search engine that may execute on user device 135, computing device 300 may build a Gaussian Mixture Model (GMM) based on a prior distribution of the data. The GMM may comprise parameters such as means, variances, and weights derived from the set of training data associated with the user application. Computing device 300 may then use the features in the sliding window to accumulate statistics such as posterior probabilities, first-, and second-order statistics.

Method 200 may then advance to stage 230 where computing device 300 may adapt at least one of the parameters associated with the GMM according to the accumulated statistics. For example, the statistics accumulated in stage 225 may be used to adapt one or more of the GMM's parameters.

Method 200 may then advance to stage 235 where computing device 300 may estimate a histogram for the at least one of the plurality of extracted features. For example, the adapted parameters of the GMM may be used to estimate a distribution for the speech feature vectors. A smoothing technique, such as linear interpolation, a non-linear interpolation, neural network-based, etc., may be applied between the updated distribution and the prior distribution. This interpolation may apply an increasing weight for the updated distribution proportional to the total amount of data available while the prior distribution may be given a decaying weight.

Method 200 may then advance to stage 240 where computing device 300 may calculate a cumulative distribution function (CDF) value for at least one feature vector. For example the CDF value may be calculated with the estimated histogram on the feature vector at time t (or at time t−n if n-frame looking ahead is allowed.) The CDF value may then used to normalize the feature to match the prior distribution. An efficient table lookup may be used to map a CDF value to a feature value.

Method 200 may then advance to stage 245 where computing device 300 may provide the at least one normalized feature vector to a spoken language understanding application. For example, HEQ 115 may provide the normalized feature to SLU 120 for further processing such as conversion to a text query and/or command. Method 200 may then end at stage 250.

An embodiment consistent with the invention may comprise a system for providing histogram equalization. The system may comprise a memory storage and a processing unit coupled to the memory storage. The processing unit may be operative to receive a spoken phrase from a user, estimate a histogram distribution on the spoken phrase according to a prior distribution, such as may be represented by a parametric model, equalize the histogram distribution, and provide the equalized histogram distribution to a spoken language understanding application.

Another embodiment consistent with the invention may comprise a system for providing histogram equalization. The system may comprise a memory storage and a processing unit coupled to the memory storage. The processing unit may be operative to extract a plurality of feature vectors from a spoken utterance associated with a user application, update a Gaussian Mixture Model (GMM) distribution based on a prior distribution of data associated with the user application according to at least one statistic associated with at least one of the plurality of feature vectors, estimate a frequency distribution of the at least one of the plurality of feature vectors according to the updated GMM distribution, normalize the at least one feature vector, and provide the normalized at least one feature vector to a spoken language understanding application.

Yet another embodiment consistent with the invention may comprise a system for providing histogram equalization. The system may comprise a memory storage and a processing unit coupled to the memory storage. The processing unit may be operative to receive a set of training data associated with an application and build a Gaussian Mixture Model (GMM) based on a prior distribution of the data, wherein the GMM comprises a plurality of mean, variance, and weight parameters derived from the set of training data associated with the user application. The processing unit may be further operative to receive a spoken utterance from a user of the user application, perform a feature extraction on the utterance, divide the extracted features into a plurality of sliding windows, wherein each of the plurality of sliding windows comprises a variable number of sampling frames, accumulate statistics on at least one of the plurality of sliding windows, wherein the accumulated statistics may be used to optimally determine the GMM parameters using at least one of the following: a maximum likelihood (ML) criterion and a maximum a posteriori (MAP) criterion, adapt at least one of the parameters associated with the GMM according to the accumulated statistics, estimate a frequency distribution for the at least one of the plurality of sliding windows, calculate a cumulative distribution function (CDF) value for at least one feature vector of the at least one of the plurality of sliding windows, normalize the at least one feature vector according to the CDF value with respect to the prior distribution of the data, and provide the at least one normalized feature vector to a spoken language understanding application.

FIG. 3 is a block diagram of a system including computing device 300. Consistent with an embodiment of the invention, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the invention. Furthermore, computing device 300 may comprise operating environment 300 as described above. Methods described in this specification may operate in other environments and are not limited to computing device 300.

With reference to FIG. 3, a system consistent with an embodiment of the invention may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include HEQ 115. Operating system 305, for example, may be suitable for controlling computing device 300's operation. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computing device 300 may also contain a communication connection 316 that may allow device 300 to communicate with other computing devices 318, such as over a network in a distributed computing environment, for example, an intranet or the Internet. Communication connection 316 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 304, including operating system 305. While executing on processing unit 302, programming modules 306 (e.g., HEQ 115) may perform processes and/or methods as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the invention may be practiced via a system-on-a-chip (SOC) where each or many of the components illustrated in FIG. 3 may be integrated onto a single integrated circuit. Such an SOC device may include one or more processing units, graphics units, communications units, system virtualization units and various application functionalities, all of which may be integrated (or “burned”) onto the chip substrate as a single integrated circuit. When operating via an SOC, the functionality, described herein, with respect to training and/or interacting with SDS 110 may operate via application-specific logic integrated with other components of the computing device/system X on the single integrated circuit (chip).

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicants. The Applicants retain and reserve all rights in the code included herein, and grant permission to reproduce the material only in connection with reproduction of the granted patent and for no other purpose.

While certain embodiments of the invention have been described, other embodiments may exist. While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method for providing histogram equalization, the method comprising:
receiving a spoken phrase from a user;
estimating a histogram distribution on the spoken phrase according to a prior distribution, wherein the prior distribution comprises a parametric model;
equalizing the histogram distribution; and
providing the equalized histogram distribution to a spoken language understanding application.

2. The method of claim 1, further comprising applying a smoothing technique between the prior distribution and the estimated histogram distribution.

3. The method of claim 1, further comprising extracting a plurality of features from the spoken phrase into a sliding window of fixed length.

4. The method of claim 2, wherein equalizing the histogram distribution comprises calculating a cumulative distribution function value for each of the plurality of features.

5. The method of claim 1, wherein the parametric model comprises a Gaussian Mixture Model (GMM).

6. The method of claim 5, further comprising adapting the prior distribution according to at least one characteristic of the spoken phrase.

7. The method of claim 6, wherein the at least one characteristic comprises a maximum likelihood (ML) criterion.

8. The method of claim 6, wherein the at least one characteristic comprises a maximum a posteriori (MAP) criterion.

9. The method of claim 5, wherein the spoken utterance is associated with a user application.

10. The method of claim 9, wherein the GMM comprises a plurality of means, variance, and weight parameters derived from a plurality of training data associated with the user application.

11. A system for providing histogram equalization, the system comprising:
a memory storage; and
a processing unit coupled to the memory storage, wherein the processing unit is operable to:
extract a plurality of feature vectors from a spoken utterance associated with a user application,
update a Gaussian Mixture Model (GMM) distribution based on a prior distribution of data associated with the user application according to at least one statistic associated with at least one of the plurality of feature vectors,
estimate a frequency distribution of the at least one of the plurality of feature vectors according to the updated GMM distribution,
normalize the at least one feature vector, and
provide the normalized at least one feature vector to a spoken language understanding application.

12. The system of claim 11, wherein the plurality of feature vectors comprise at least one of the following: a plurality of Mel-frequency cepstral coefficients (MFCC) feature vectors and a plurality of perceptual linear predictive (PLP) feature vectors.

13. The system of claim 11, wherein the processing unit is further operative to apply a linear interpolation between the prior distribution and the updated GMM distribution.

14. The system of claim 13, wherein the updated GMM distribution receives a higher weighting than the prior distribution.

15. The system of claim 14, wherein the higher weighting is proportional to a total length of the spoken utterance.

16. The system of claim 14, wherein being operative to normalize the at least one feature vector comprises being operative to:
calculate a cumulative distribution function on the frequency distribution; and
normalize the at least one feature vector to match the prior distribution according to the cumulative distribution function.

17. The system of claim 11, wherein the processing unit is further operative to execute the spoken language understanding application, wherein the spoken language understanding application is operative to convert the normalized at least one feature vector to a text string.

18. The system of claim 17, wherein the spoken language understanding application is further operative to perform an action according to the spoken utterance associated with the user application.

19. The system of claim 18, wherein the spoken language understanding application is further operative to provide a result of performing the action to the user.

20. A computer-readable medium which stores a set of instructions which when executed performs a method for providing histogram equalization, the method executed by the set of instructions comprising:
receiving a set of training data associated with an application;
building a Gaussian Mixture Model (GMM) based on a prior distribution of the data, wherein the GMM comprises a plurality of mean, variance, and weight parameters derived from the set of training data associated with the user application;
receiving a spoken utterance from a user of the user application;
performing a feature extraction on the utterance, wherein performing the feature extraction comprises parameterizing a signal of the spoken utterance into a plurality of feature vectors and wherein the plurality of feature vectors comprise at least one of the following: a plurality of Mel-frequency cepstral coefficients (MFCC) feature vectors and a plurality of perceptual linear predictive (PLP) feature vectors;
buffering each of the extracted features into a sliding window, wherein the sliding window comprises a variable number of sampling frames;
accumulating statistics on at least one of the extracted features, wherein the accumulated statistics comprise at least one of the following: a maximum likelihood (ML) criterion and a maximum a posteriori (MAP) criterion;
adapting at least one of the parameters associated with the GMM according to the accumulated statistics;
estimating a frequency distribution for the at least one of the plurality of extracted features;
calculating a cumulative distribution function (CDF) value for at least one feature vector of the at least one of the plurality of extracted features;
normalizing the at least one feature vector according to the CDF value with respect to the prior distribution of the data; and
providing the at least one normalized feature vector to a spoken language understanding application.
